(19) United States
(12) Patent Application Publication
(10) Pub. No.: US 2024/0385401 A1
(43) Pub. Date: Nov. 21, 2024

(54) OPTICAL DEVICE AND METHOD FOR FORMING THE SAME

(71) Applicant: Singapore University of Technology & Design, Singapore (SG)

(72) Inventor: Dawn TAN, Singapore (SG)

(73) Assignee: Singapore University of Technology & Design, Singapore (SG)

(21) Appl. No.: 18/696,205

(22) PCT Filed: Sep. 27, 2022
(86) PCT No.: PCT/SG2022/050695

§ 371 Date: Mar. 27, 2024

(30) Foreign Application Priority Data
Sep. 27, 2021 (SG) 10202110716W

(51) Int. Cl. G02B 6/43; H04B 10/2519; H04B 10/58; H04B 10/60

(52) U.S. Cl. CPC G02B 6/43; H04B 10/2519; H04B 10/58; H04B 10/60

(57) ABSTRACT

According to embodiments of the present disclosure, an optical device for dispersion compensation is provided. The optical device may include a channel waveguide and two sidewalls coupled to at least a portion of the channel waveguide. The two sidewalls may be respectively arranged at opposing sides of the channel waveguide along a longitudinal axis of the channel waveguide. Each of the two sidewalls may include a plurality of optical elements arranged along the channel waveguide of the waveguide, and the plurality of optical elements may be configured to interact with light propagating in the waveguide so as to compensate dispersion of the light by transmitting the light in a regime close to a stopband of the plurality of optical elements defined by a period of the plurality of optical elements.

### TECHNICAL FIELD

Various embodiments relate to an optical device and a method for forming an optical device.

### BACKGROUND

Globally, transceiver companies serving the intra-data center, inter-data center and core/metro markets need to continuously scale their bandwidths to match the burgeoning pace in cloud computing services, e-commerce, supercomputing and future 5G networks. Multi-source agreements (MSAs) amongst companies allow alignment of technological strategies and architectures. MSAs including the Parallel Single Mode 4 (PSM4), 100G Serial Lambda MSA/Ethernet Alliance, OpenEye, are opting for Pulse Amplitude Modulation (PAM) to scale to higher data rates. The decision to adopt PAM by these companies arises from the 2 times, 3 times, 4 times (PAM4, 6, 8 respectively) higher data rates compared to non-return-to-zero (NRZ) while maintaining direct detect schemes, significantly reducing cost, power and latency. Both NRZ and PAM data suffer for dispersion limitations, with increasing severity for higher level PAM. Without proper consideration or management for dispersion in the system, transmitted data suffers from a dispersion penalty which can be quantified as a power loss in dB due to the closure of the NRZ or PAM eye. Left unmitigated, the dispersion penalty causes inter-symbol interference leading to high bit error rates at the receiver and data loss.

Therefore, there exists a need for dispersion compensation for the data.

### SUMMARY

According to a first aspect of the present disclosure, an optical device for dispersion compensation is provided. The optical device may include a channel waveguide and two sidewalls coupled to at least a portion of the channel waveguide, the two sidewalls respectively arranged at opposing sides of the channel waveguide along a longitudinal axis of the channel waveguide, wherein each of the two sidewalls comprises a plurality of optical elements arranged along the channel waveguide of the waveguide, and the plurality of optical elements are configured to interact with light propagating in the waveguide so as to compensate dispersion of the light by transmitting the light in a regime close to a stopband of the plurality of optical elements defined by a period of the plurality of optical elements.

According to a second aspect of the present disclosure, a method for forming an optical device is provided. The method may include: forming a channel waveguide; and forming two sidewalls coupled to at least a portion of the channel waveguide by at least one of ion-implantation or photo lithography, the two sidewalls respectively arranged at opposing sides of the channel waveguide along a longitudinal axis of the waveguide, wherein each of the two sidewalls comprises a plurality of optical elements extending to a respective side opposite to the portion of the channel waveguide of the waveguide, and the plurality of optical elements interact with light propagating in the waveguide so as to compensate dispersion of the light by transmitting the light in a regime close to a stopband of the plurality of optical elements defined by a period of the plurality of optical elements.

According to a third aspect of the present disclosure, an optical device is provided. The optical device may include a waveguide; and a Bragg grating fiber defined in at least a portion of the waveguide, wherein the Bragg grating fiber is configured to interact with light propagating in the waveguide so as to compensate dispersion of the light by transmitting the light in a regime close to a stopband of the Bragg grating fiber.

### BRIEF DESCRIPTION OF THE DRAWINGS

In the drawings, like reference characters generally refer to like parts throughout the different views. The drawings are not necessarily to scale, emphasis instead generally being placed upon illustrating the principles of the disclosure. In the following description, various embodiments of the disclosure are described with reference to the following drawings, in which:

FIG. 1A shows a schematic perspective view of an example optical device, according to various embodiments; FIG. 1B shows a schematic perspective view of another example optical device, according to various embodiments.

FIG. 2 shows a block diagram of an example optical system, according to various embodiments.

FIG. 3 shows a flow chart illustrating a method for forming an example optical device, according to various embodiments.

FIGS. 4A and 4B show respective plots of the transmission and differential group delay characteristics of an example optical device, according to various embodiments.

FIGS. 5A to 5F show eye diagrams measured using a digital sampling oscilloscope for transmission data.

### DETAILED DESCRIPTION

The following detailed description refers to the accompanying drawings that show, by way of illustration, specific details and embodiments in which the disclosure may be practiced. These embodiments are described in sufficient detail to enable those skilled in the art to practice the disclosure. Other embodiments may be utilized and structural, logical, optical and electrical changes may be made without departing from the scope of the disclosure. The various embodiments are not necessarily mutually exclusive, as some embodiments can be combined with one or more other embodiments to form new embodiments.

Embodiments described in the context of one of the methods or devices are analogously valid for the other methods or devices. Similarly, embodiments described in the context of a method are analogously valid for a device, and vice versa.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

It should be understood that the terms “on”, “over”, “top”, “bottom”, “down”, “side”, “back”, “left”, “right”, “front”, “back”, “lateral”, “side”, “up”, “down”, “vertical”, “horizontal” etc., when used in the following description are used for convenience and to aid understanding of relative positions or directions, and not intended to limit the orientation of any device, or structure or any part of any device or structure. In addition, the singular terms “a”, “an”, and “the” include plural references unless context clearly indicates otherwise. Similarly, the word “or” is intended to include “and” unless the context clearly indicates otherwise.

It will be further understood that the terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. As a result, a method or device that “comprises,” “has,” “includes” or “contains” one or more steps or elements possesses those one or more steps or elements, but is not limited to possessing only those one or more steps or elements. Likewise, a step of a method or an element of a device that “comprises,” “has,” “includes” or “contains” one or more features possesses those one or more features, but is not limited to possessing only those one or more features. Furthermore, a device or structure that is configured in a certain way is configured in at least that way, but may also be configured in ways that are not listed.

Approximating language, as used herein throughout the specification and claims, may be applied to modify any quantitative representation that could permissibly vary without resulting in a change in the basic function to which it is related. Accordingly, a value modified by a term or terms, such as “about,” “substantially”, is not limited to the precise value specified but within tolerances that are acceptable for operation of the embodiment for an application for which it is intended. In some instances, the approximating language may correspond to the precision of an instrument for measuring the value.

As used herein, the phrase of the form of “at least one of A or B” may include A or B or both A and B. Correspondingly, the phrase of the form of “at least one of A or B or C”, or including further listed items, may include any and all combinations of one or more of the associated listed items.

Chromatic dispersion is intrinsically a linear optical mechanism, management of dispersion may be in practice implemented along any part of the link. For example, pre-compensation prior to data transmission in the fiber (transmitter side), periodic compensation in the fiber link or post-compensation (receiver side) may be all possible approaches. Viable approaches for integrated dispersion management may allow significantly higher data rates to be adopted in these transceiver products or optical communications links, and/or increase the reaches that they could serve.

Various embodiments may provide a low loss, transmission grating providing dispersion compensation at telecommunications wavelengths (e.g. 2 km of optical fiber transmission). The transmission grating may be complementary metal-oxide-semiconductor (CMOS) compatible. The proposed device has shown low insertion losses (e.g. less than 1.5 dB), providing a high aggregate dispersion (e.g. 31 ps/nm). High speed data measurements are performed and show restoration of the eye diagrams for 30 Gb/s non-return-to-zero (NRZ) and 30 Gbaud/s (60 Gb/s) PAM4 data. The low loss of the grating device may also allow room for further scalability, such that dispersion compensation of longer fibers may potentially be realized as well by appropriately designing the length of the device to match the required magnitude of dispersion.

Various embodiments may provide an optical device capable of compensating dispersion. The proposed device (e.g., an integrated photonic device) may be implemented on or integrated with a CMOS device. The proposed device may include a channel waveguide and two sidewalls coupled (e.g. integral or attached) to at least a portion (e.g. a center portion, a side portion or a whole length) of the channel waveguide. The two sidewalls may be respectively arranged at opposing sides of the channel waveguide along a longitudinal axis of the channel waveguide (e.g. propagation direction). Each of the two sidewalls may include a plurality of optical elements arranged along the channel waveguide and the two sidewalls may have modulated profiles. In some embodiments, the amplitude of the two sidewall modulation may have a raised cosine profile, or any other profile including, but not limited to cosine, Blackman, Gaussian and hyperbolic tangent. Accordingly, the proposed device may include a waveguide with (sinusoidally) modulated sidewalls. The plurality of optical elements may be configured to interact with light propagating in the channel waveguide so as to compensate dispersion of the light by transmitting the light in a regime close to a stopband of the plurality of optical elements defined by a period (e.g. a pitch) A of the plurality of optical elements.

The modulated sidewalls may function as a periodic structure (e.g., a Bragg grating). A Bragg grating is a type of distributed Bragg reflector constructed in a segment of optical propagation medium that reflects particular wavelengths of light and transmits all others. The operating wavelength of a Bragg grating, λ, is governed by the Bragg condition, λ=2·n_{eff}·Λ, where n_{eff} is the effective index of the waveguide. In other words, the Bragg grating may define a stopband for signals with a wavelength of the operating wavelength λ that are reflected by the grating. Gratings may exhibit strong dispersion in transmission for frequencies (e.g. or wavelengths) close to the Bragg stopband (e.g. resonance). This dispersion, which does not rely on any chirp or other grating nonuniformity, may be due to the strong frequency dependence of the group velocity of light propagating through a grating. In effect, close to the Bragg resonance, but not so close so as to be inside the photonic bandgap where the reflectivity is high, light may be slowed down because of multiple Fresnel reflections off the rulings of the grating. Strong dispersion may be induced at frequencies (e.g. or wavelengths) close to the edge of the stopband of a Bragg grating. In the regime close to the grating stopband (e.g. outside of the stopband, close to the blue/red edges), transmissivity may be high and there may exist a rapid increase in group index. On the blue-side of the grating stopband, dispersion may be large and anomalous (e.g. positive), whereas on the red-side, dispersion may be also large but normal (e.g. negative).

Various embodiments may provide an optical device compensating dispersion by operation of transmission. The proposed device may operates in transmission on a red-side (i.e. the longer wavelength side) of a stopband of a grating (e.g. the plurality of optical elements). The plurality of optical elements may be configured to interact with the light propagating in the waveguide so as to compensate positive dispersion of the light by transmitting the light in a regime close to a red-side of the stopband of the plurality of optical elements where the transmission causes negative dispersion. This was to ensure that the generated dispersion by the optical device may be normal and the dispersion slope was negative, so as to compensate for the anomalous dispersion and positive dispersion slope in the input light. Therefore, the optical device may be characterized by normal dispersion having a negative dispersion slope suitable or ideal for compensating for positive dispersion that is caused by transmission in an optical fiber. To compensate for light propagating at wavelengths where the fiber dispersion is normal, then the grating's blue-edge (short wavelength side) may be used so as to generate anomalous dispersion to counter the fiber's normal dispersion. For example, for a standard single mode fiber, as the dispersion is normal at wavelengths below ˜1300 nm, the blue edge of the grating where dispersion is anomalous may be used.

In various embodiment, the proposed optical device for compensating dispersion may not require a circulator as in the reflection gratings as the mode of operation of the proposed grating is in transmission mode. Rather than relying on differential propagation lengths from a linearly decreasing grating pitch in the reflection gratings, the differential group delays experienced by different wavelengths of light in the proposed device may arise from the interaction between the forward and backward propagating optical fields as a result of the artificial bandgap of the grating.

In some instances, aspects of the devices and techniques described here provide technical improvements and advantages over existing approaches. For example, the proposed optical devices may provide dispersion compensation by transmitting light in a regime close to the stopband of the plurality of optical elements defined by a period of the plurality of optical elements. In other words, to compensate dispersion of a light having (e.g. including) certain wavelength(s) and negative or positive dispersions, the plurality of optical elements may be so designed to have a period Λ and a corresponding stopband λ(Λ) that the certain wavelength(s) of light falls immediately outside the stopband (e.g. on the edge of the stopband where transmission is high) where strong dispersion occurs. Consequently, the negative or positive dispersions of the light may be compensated by transmitting in a regime close to (e.g. immediate outside the stopband) the blue (e.g. to compensate negative dispersion) or red (e.g. to compensate positive dispersion) sides the stopband of the plurality of optical elements.

In an example, a raised cosine apodization of the grating (e.g. the plurality of corrugated structures) may be implemented by gradually increasing the sidewall modulation amplitude from zero to both ends of the sidewalls (e.g. ends of the waveguide when the sidewalls extend a whole length of the waveguide) to its maximum value (e.g. 150 nm) at the center of the sidewalls (e.g. the center of the waveguide when the sidewalls is disposed at the center portion of the waveguide). The apodization may help to eliminate or minimise group delay ripple by providing a smooth transition from the waveguide to the plurality of corrugated structures.

In various embodiments, the optical devices including dispersive elements capable of compensating for dispersion by way of transmission mode will now be described by way of the following non-limiting examples.

The following examples pertain to various aspects of the present disclosure.

Example 1 is an optical device for dispersion compensation including: a channel waveguide and two sidewalls coupled to at least a portion of the channel waveguide, the two sidewalls respectively arranged at opposing sides of the channel waveguide along a longitudinal axis of the channel waveguide, wherein each of the two sidewalls comprises a plurality of optical elements arranged along the channel waveguide of the waveguide, and the plurality of optical elements are configured to interact with light propagating in the waveguide so as to compensate dispersion of the light by transmitting the light in a regime close to a stopband of the plurality of optical elements defined by a period of the plurality of optical elements.

In Example 2, the subject matter of Example 1 may optionally include that the plurality of optical elements are configured to interact with the light propagating in the channel waveguide so as to compensate positive dispersion of the light by transmitting the light in a regime close to a red-side of the stopband of the plurality of optical elements where the transmission causes negative dispersion.

In Example 3, the subject matter of Example 1 may optionally include that the plurality of optical elements have a sinusoidal profile.

In Example 4, the subject matter of Example 3 may optionally include that the sidewalls are apodized in a manner that an amplitude is equal to zero at two ends of the sidewalls and gradually increases from the two ends to a center portion of the sidewalls.

In Example 5, the subject matter of Example 5 may optionally include that the amplitude at the center portion of the sidewalls is about one tenth of a width of the channel waveguide of the waveguide.

In Example 6, the subject matter of Example 1 may optionally include that the channel waveguide is made of silicon nitride materials.

In Example 7, the subject matter of Example 1 may optionally include that the channel waveguide of the waveguide has a width in a range of 500 nm to 1.5 μm and a height in a range of 150 nm to 2 μm.

In Example 8, the subject matter of Example 1 may optionally include that the period of the plurality of optical elements of one of the two sidewalls of the channel waveguide is at least substantially similar to the period of the plurality of optical elements of the other of the two sidewalls of the channel waveguide.

In Example 9, the subject matter of Example 1 may optionally include a cladding arranged over the channel waveguide and the plurality of optical elements.

In Example 10, the subject matter of Example 9 may optionally include that the cladding is silicon dioxide in a range of 1 to 5 μm.

In Example 11, the subject matter of Example 1 may optionally include a grating coupler or an inverse tapering region at an end region of the channel waveguide.

In Example 12, the subject matter of Example 1 may optionally include a carrier, wherein the channel waveguide is formed on the carrier.

In Example 13, the subject matter of Example 1 may optionally include that the plurality of optical elements form a Bragg grating.

In Example 14, the subject matter of Example 13 may optionally include that the stopband of the plurality of optical elements is configured to be longer than a wavelength of the light having the dispersion by a range of 0.1 nm to 1 nm.

Example 15 is an optical system comprising: an optical transmitter for providing at least one optical signal; an optical fiber coupled to the optical transmitter for receiving and transmitting the at least one optical signal; the optical device of any one of claims 1 to 14 for compensating dispersion of the at least one optical signal induced by the transmission in the optical fiber; and an optical receiver.

In Example 16, the subject matter of Example 15 may optionally include that the optical device is integrated with the optical transmitter or the optical receiver in a manner that the optical transmitter or the optical receiver is a system-on-a-chip.

In Example 17, the subject matter of Example 15 may optionally include that the optical transmitter comprises a multiwavelength optical transmitter for providing a plurality of wavelength-distinct optical signal and the optical receiver comprises a multiwavelength optical receiver.

In Example 18, the subject matter of Example 15 may optionally include that the multiwavelength optical transmitter is configured to provide C-band and L-band wavelength optical signals.

In Example 19, the subject matter of Example 15 may optionally include that the optical transmitter is configured to provide modulated signals including Pulse Amplitude Modulation (PAM) and non-return-to-zero (NRZ) modulated signals.

In Example 20, the subject matter of Example 15 may optionally include that the optical fiber is a single mode fiber.

In Example 21, the subject matter of Example 20 may optionally include that a length of the optical fiber is at least 2 km.

In Example 22, the subject matter of Example 15 may optionally include an erbium doped fiber amplifier and a bandpass filter coupled between the optical fiber and the optical device, wherein the optical device is configured to receive an output from the bandpass fiber and to compensate dispersion of the output.

In Example 23, the subject matter of Example 15 may optionally include that the optical receiver is configured to convert optical signals to electrical signals.

In Example 24, the subject matter of Example 23 may optionally include a digital sampling oscilloscope for analyzing the converted electrical signals.

Example 25 is a method for forming an optical device, the method comprising: forming a channel waveguide; and forming two sidewalls coupled to at least a portion of the channel waveguide by at least one of ion-implantation or photo lithography, the two sidewalls respectively arranged at opposing sides of the channel waveguide along a longitudinal axis of the waveguide, wherein each of the two sidewalls comprises a plurality of optical elements extending to a respective side opposite to the portion of the channel waveguide of the waveguide, and the plurality of optical elements interact with light propagating in the waveguide so as to compensate dispersion of the light by transmitting the light in a regime close to a stopband of the plurality of optical elements defined by a period of the plurality of optical elements.

Example 26 is an optical device comprising: a waveguide; and a Bragg grating defined in at least a portion of the waveguide, wherein the Bragg grating is configured to interact with light propagating in the waveguide so as to compensate dispersion of the light by transmitting the light in a regime close to a stopband of the Bragg grating.

Example 27 is use of the optical device of any one of claims 1 to 14 in dispersion compensation of a light, comprising: transmitting the light in the regime close to the stopband of the plurality of optical elements defined by the period of the plurality of optical elements, wherein the light has a positive dispersion and the light has a wavelength longer than the stopband of the plurality of optical elements by a range of 0.1 nm to 1 nm, or wherein the light has a negative dispersion and the light has a wavelength shorter than the stopband of the plurality of optical elements by a range of 0.1 nm to 1 nm.

The design, fabrication, and measurement characterization of the optical devices (e.g. silicon waveguide gratings) have been performed, as will be described later below.

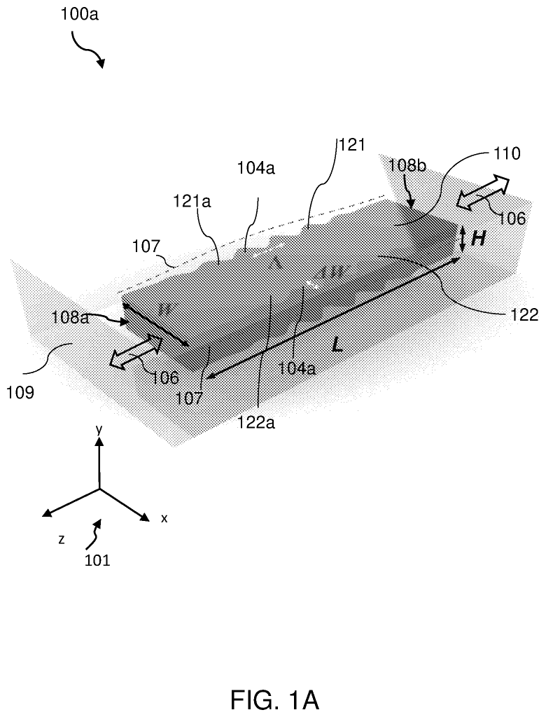

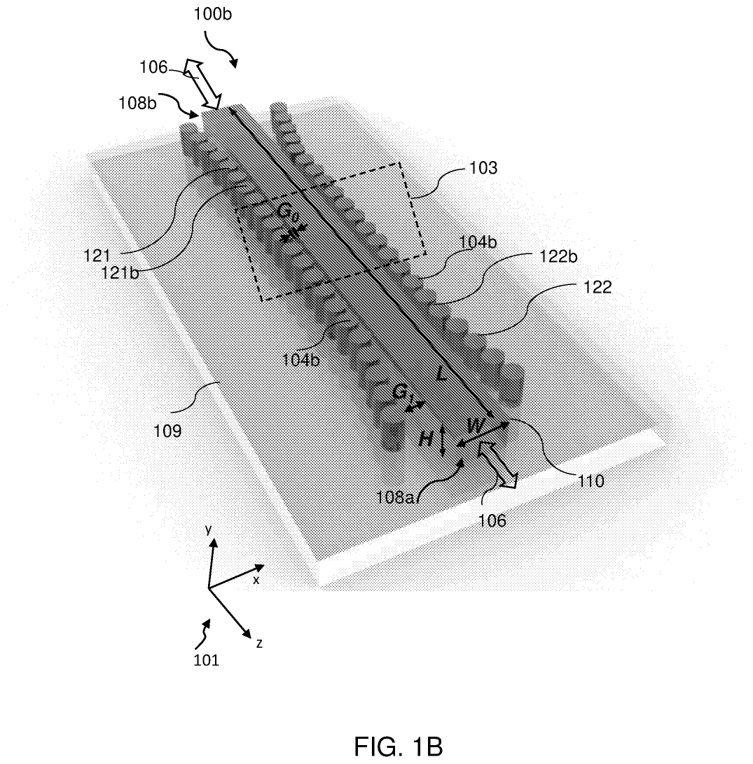

The design for the optical devices of various embodiments will now be described. FIG. 1A shows a schematic perspective view of an optical device 100a, according to various embodiments. FIG. 1B shows a schematic perspective view of another optical device 100b, according to various embodiments. FIGS. 1A and 1B show a frame of reference 101 having three orthogonal axes. The frame of reference 101 includes a first axis in a first direction (e.g., the x-direction), a second axis in a second direction (e.g., the y-direction), and a third axis in a third direction (e.g., the z-direction). The first, second, and third directions are perpendicular to each other.

The optical device 100a, 100b may include a channel waveguide 110. In the context of various embodiments, a “channel waveguide” may refer to a waveguide that may confine one or more optical modes in at least two dimensions, e.g., in the transverse directions (x- and y-directions) such that the mode is guided and propagates along a longitudinal axis of the waveguide (L), e.g., along the z-direction (direction of propagation of the light 106). Propagation of the optical mode may be allowed along one dimension only, for example, along the z-direction. This confinement of the optical mode in the transverse directions in a channel waveguide may be achieved via incorporating a cladding material around the channel waveguide or the waveguide core in all transverse directions. In various embodiments, a channel waveguide may include at least one planar surface. In this way, for example, the channel waveguide may be or may include a planar waveguide, where the planar waveguide may confine one or more optical modes in at least two dimensions, e.g., in the transverse directions (x- and y-directions). As a non-limiting example, a channel waveguide may include a planar surface defined along the width (W) direction (e.g., x-direction) and/or the height (H) direction (e.g., y-direction) of the channel waveguide. In various embodiments, a channel waveguide may include planar surfaces aligned along the transverse directions (x- and y-directions).

In various embodiments, the optical device 100a, 100b may further include two sidewalls 121, 122 coupled to at least a portion of the channel waveguide 110. The two sidewalls 121, 122 may be respectively arranged at opposing sides of the channel waveguide 110 along the longitudinal axis of the channel waveguide 110. The longitudinal axis of the channel waveguide 110 may be parallel to the z-direction. Each of the two sidewalls 121, 122 of the optical device 100a, 100b may include a plurality of optical elements 121a, 122a, 121b, 122b . . . . The channel waveguide 110 may be sandwiched by the two sidewalls 121, 122 arranged on opposite sides of the channel waveguide 110.

In various embodiments, the plurality of optical elements 121a (e.g. corrugated structures) of the sidewalls 121 of the optical device 100a may be arranged on a first side of the channel waveguide 110 and extending away from the first side of the channel waveguide 110, and the plurality of optical elements 122a (e.g. corrugated structures) of the sidewalls 122 of the optical device 100a may be arranged on a second side of the channel waveguide 110 and extending away from the second side of the channel waveguide 110, where the first and second sides are opposite sides. Stated differently, the channel waveguide 110 may have modulated sidewalls 121, 122. The two sidewalls 121, 122 of the optical device 100a may be integral or attached to the at least a portion of the channel waveguide 110.

In various embodiments, the plurality of optical elements 121b, 122b (e.g. periodic cylinders) of the sidewalls 121, 122 of the optical device 100b may be arranged spaced apart from opposite sides of the channel waveguide 110. In various embodiments, the plurality of optical elements 121b, 122b may include cylindrical elements. The cylindrical elements 104b may be arranged spaced apart from opposite sides of the channel waveguide 110. As a non-limiting example, a first set of the cylindrical elements 104b may be arranged on a first side of the channel waveguide 110, spaced apart from a first side of the channel waveguide 110, and a second set of the cylindrical elements 104b may be arranged on a second side of the channel waveguide 110, spaced apart from a second side of the channel waveguide 110, where the first and second sides are opposite sides. In various embodiments, the cylindrical elements 104b located at a central region may be spaced apart from the opposite sides of the channel waveguide 110 at a first distance, shorter than a second distance at which the cylindrical elements 104b located at an edge region are spaced apart from the opposite sides of the channel waveguide 110. The optical device 100b may provide a different effective index modulation format from the optical device 100a. In various embodiments, the cylindrical elements 104b located at a central region as shown in box denoted as 103 may be equally spaced apart from the opposite sides of the channel waveguide 110.

Features that are described in the context of the optical device 100a may correspondingly be applicable to the same or similar features in the optical device 100b. Furthermore, additions and/or combinations and/or alternatives as described for a feature in the context of the optical device 100a may correspondingly be applicable to the same or similar feature in the optical device 100b.

In various embodiments, the plurality of corrugated structures 121a, 122a (having a period or pitch, A) of the optical device 100a may function as or similar to a grating. For example, corresponding peaks 104a (or troughs) of the corrugations defined on opposite sides of the channel waveguide 110 may be arranged coaxially along an axis (e.g. x-direction) that is at least substantially perpendicular to the longitudinal axis of the channel waveguide 110. Similarly, the plurality of cylindrical elements 121b, 122b (having a period or pitch, Λ) of the optical device 100b may function as or similar to a grating.

In various embodiments, the period Λ of the plurality of corrugated structures 121a, 122a arranged on one side (e.g. a first side) of the channel waveguide 110 may change in sync with the period Λ of the plurality of corrugated structures 121a, 122a arranged on the opposite side (e.g. a second side) of the channel waveguide 110. This may mean that the periods, Λ, of the plurality of corrugated structures 121a, 122a arranged on opposite sides (e.g. first and second sides) of the channel waveguide 110 may be at least substantially the same or identical.

In various embodiments, the corrugations 104a may have a sinusoidal profile. In other words, the channel waveguide 110 may include sinusoidally modulated sidewalls. This may mean that the optical device 100a of various embodiments may include a sinusoidally corrugated waveguide grating. It should be appreciated that other sidewall modulation types which provide an effective index modulation such as rectangular corrugations (e.g., rectangular profile), cladding modulation etc. may also be used. The sinusoidal sidewall configuration as show in FIG. 1A may be employed for its ease of fabrication with single-step lithography.

In various embodiments, a depth (or modulation amplitude), ΔW, of the corrugations 104a may be in a range of between about 30 nm and about 500 nm, for example, between about 50 nm and about 400 nm, between about 100 nm and about 300 nm, or between about 120 nm and about 180 nm, e.g., about 100 nm, about 150 nm or about 180 nm. It should be appreciated that the dimension of the depth, ΔW, of the corrugations 104a may be varied based on the type of waveguide platform used. Further, the modulation amplitude, ΔW, of the sidewalls may be dependent on a width of the channel waveguide 110. For example, the modulation amplitude, ΔW, may be in a range of 30 nm to 500 nm for a width, W, of the channel waveguide of 1.5 μm. As a non-limiting example, the depth, ΔW, of the corrugations 104a may be about 150 nm. The term “depth” may refer to the distance or spacing between the maximum plane and the minimum plane of the corrugations 104a. In various embodiments, the maximum plane may correspond to the peaks of the corrugations 104a, and/or the minimum plane may correspond to the troughs of the corrugations 104a. In various embodiments, the depth of the corrugations 104a may change along the portion of the channel waveguide 110.

In various embodiments, the sidewalls 121, 122 may be apodized along the longitudinal axis of the waveguide 110 of the optical device 100a by gradually increasing the modulated amplitude ΔW from zero at both ends to its maximum at the center of the sidewalls 121, 122. In other words, the plurality of corrugated structures 121a, 122a may be apodized in a manner that an amplitude ΔW is equal to zero at two ends of the sidewalls 121, 122 and gradually increases from the two ends to a center portion of the sidewalls 121, 122. The amplitude at the center portion of the sidewalls may be about one tenth of a width of the channel waveguide 110. The apodization may help to eliminate or minimise group delay ripple as well as ripple within the passband. A maximum of ΔW at the center portion of the sidewalls 121, 122 may be 150 nm. In this configuration, the calculated coupling coefficient is ˜20,000 m⁻¹. For example, the plurality of corrugated structures 121a, 122a may have a raised sine (or cosine) apodization profile. The dashed lines 107 denotes the sidewall modulation amplitude's envelope following a raised sine (or cosine) profile.

In various embodiments, a distance (or modulation amplitude), G, of the cylindrical elements 104b may be in a range of between about 30 nm and about 500 nm, for example, between about 50 nm and about 400 nm, between about 100 nm and about 300 nm, or between about 120 nm and about 180 nm, e.g., about 100 nm, about 150 nm or about 180 nm. It should be appreciated that the dimension of the distance, G, of the cylindrical elements 104b may be varied based on the type of waveguide platform used. Further, the distance G may be dependent on a width of the channel waveguide 110. For example, the distance G may be in a range of 30 nm to 300 nm for a width, W, of the channel waveguide of 500 nm. As a non-limiting example, a minimum of the distance, G₀, of the cylindrical elements 104b may be about 50 nm. As a non-limiting example, a maximum of the distance, G₁, of the cylindrical elements 104b may be about 150 nm. The term “distance” may refer to the distance or spacing between the sides of the waveguide 110 and a side (e.g. a nearest side) of the cylindrical elements 104b (a gap between the cylindrical elements 104b and the channel waveguide 110). In various embodiments, the distance of the cylindrical elements 104b may change along the portion of the channel waveguide 110. In some embodiments, the variation of the distance G may have a raised cosine profile, or any other profile including, but not limited to cosine, Blackman, Gaussian and hyperbolic tangent.

In various embodiments, the two sidewalls 121, 122 may be coupled to a center portion of the channel waveguide 110 in a manner that left sections and right sections of the two sidewalls 121, 122 may be symmetric about a center axis (e.g. x-direction) of the waveguide 110. In various embodiments, the two sidewalls 121, 122 may be coupled to a side portion of the channel waveguide 110 (e.g. starting from or near an end 108a/108b of the waveguide 110).

In various embodiments, the plurality of optical elements 121a, 122a, 121b, 122b may be arranged relative to the portion of the channel waveguide 110 such that the plurality of optical elements 121a, 122a, 121b, 122b may interact with the light 106 propagating in the channel waveguide 110. The plurality of optical elements 121a, 122a, 121b, 122b may interact with the optical mode of the light 106 and/or the evanescent wave (or evanescent mode) of the light 106. The plurality of optical elements 121a, 122a, 121b, 122b may be configured to interact with light propagating in the waveguide 110 so as to compensate dispersion of the light by transmitting the light in a regime close to a stopband of the plurality of optical elements 121a, 122a, 121b, 122b defined by the period (or a pitch), Λ, of the plurality of optical elements 121a, 122a, 121b, 122b.

The plurality of optical elements 121a, 122a, 121b, 122b may be arranged such that the period Λ of the plurality of optical elements 121a, 122a, 121b, 122b may be configured to have a desired stopband, λ(Λ). For example, according to the Bragg condition as described herein, a grating with a period of Λ=434 nm may correspond to a Bragg wavelength (i.e. stopband) of λ(Λ)=1576 nm. By “a regime close to a stopband”, it may mean a range of wavelengths immediate shorter or longer than the stopband, that is, shorter or longer wavelengths immediate outside the stopband, by a range of between about 1 nm and about 0.1 nm, between about 0.9 nm to about 0.2 nm, between 0.8 nm to about 0.3 nm, about 1 nm, 0.9 nm, 0.8 nm, 0.5 nm, 0.3 nm, 0.2 nm or 0.1 nm. The regime close to a stopband may be dependent on the material that the grating is implanted as well as the height/width of the grating. For example, for a higher index material (e.g. a grating implemented in silicon with a height of 250 nm and a width of 500 nm), the regime close to a stopband may be 1 nm to 15 nm. Accordingly, it should be appreciated that “a regime close to a stopband” includes regions on the edges of the stopband where the transmission is high.

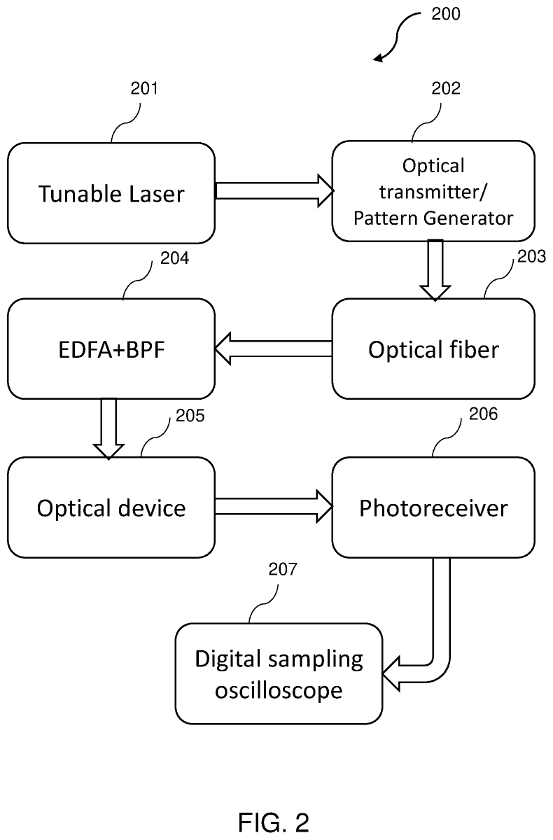

Accordingly, the grating with the period of Λ=434 nm corresponding to the Bragg wavelength of λ(Λ)=1576 nm may be designed to compensate a dispersion of a light with a wavelength of 1576.2 nm as described below with reference to FIGS. 2, 4A-4B and 5A-5F.

In other words, an optical device 100a, 100b of various embodiments may include a channel waveguide 110. The channel waveguide 110 may receive light, as represented by the arrows 106. The channel waveguide 110 may include two ends 108a, 108b as an optical input/output (I/O) port where light 106 may be launched or provided into the channel waveguide 110 via either or both of the two ends 108a, 108b. Light 106 with a dispersion (e.g. a positive dispersion) launched through the end 108a may be output, with the dispersion compensated (e.g., by a negative dispersion of the grating (the plurality of optical elements 121a, 122a, 121b, 122b)), through the end 108b.

In some embodiments, the plurality of optical elements 121a, 122a, 121b, 122b may be configured to interact with light propagating in the waveguide 110 so as to compensate dispersion of the light by transmitting the light in a regime close to a red side (longer wavelength) of the stopband of the plurality of optical elements 121a, 122a, 121b, 122b defined by the period Λ of the plurality of optical elements 121a, 122a, 121b, 122b. By “a regime close to a red side of the stopband”, it may mean a range of wavelengths immediate longer than the stopband, that is, longer wavelengths immediate outside the stopband, by a range of between about 1 nm and about 0.1 nm, between about 0.9 nm to about 0.2 nm, between 0.8 nm to about 0.3 nm, about 1 nm, 0.9 nm, 0.8 nm, 0.5 nm, 0.3 nm, 0.2 nm or 0.1 nm. The red side (longer wavelength) of the stopband of the plurality of optical elements 121a, 122a, 121b, 122b may provide a negative dispersion (i.e. providing a delay to shorter wavelengths relative to the longer wavelengths) so as to compensate a positive dispersion of a light propagating in the waveguide 102. Similarly as described above, it should be appreciated that “a regime close to a red side of the stopband” includes a region on the red edge (the longer wavelengths) of the stopband where the transmission is high.

The plurality of the plurality of optical elements 121a, 122a, 121b, 122b may act to compensate for inherent dispersive property of the channel waveguide 110. The inherent dispersive property may include a group delay and/or a dispersion extracted from the group delay. In this way, the plurality of the plurality of optical elements 121a, 122a, 121b, 122b and the channel waveguide 110 may cooperate to define an effective dispersive property for the channel waveguide 110. The plurality of optical elements 121a, 122a, 121b, 122b may be so designed that the effective dispersive property for the channel waveguide 110 (i.e. the dispersion effect of the optical device 100a, 100b) compensates the dispersion of the light 106. Specifically, the plurality of optical elements 121a, 122a, 121b, 122b may be configured to interact with light propagating in the waveguide 110 so as to compensate dispersion of the light 106 by transmitting the light in the regime close to the stopband of the plurality of optical elements 121a, 122a, 121b, 122b defined by the period (or a pitch), Λ, of the plurality of optical elements 121a, 122a, 121b, 122b, as described above. In various embodiments, interaction between the light 106 propagating in the channel waveguide 110 and the plurality of optical elements 121a, 122a, 121b, 122b may include the interaction between the forward and back propagating optical fields (e.g. light) as a result of the artificial bandgap of the grating (the plurality of optical elements 121a, 122a, 121b, 122b). This may mean reflection and transmission of the light 106 by the plurality of optical elements 121a, 122a, 121b, 122b interact each other.

In various embodiments, the optical device 100a, 100b may further include a cladding arranged or formed over the channel waveguide 110 and the plurality of optical elements 121a, 122a, 121b, 122b by using UV lithography. The upper cladding may include but not limited to silicon dioxide. A thickness of the cladding may be about 1-5 μm, for example 2 μm. It should be appreciated that other materials may be used, including other dielectric and semiconductor materials. The cladding may have a refractive index that is lower than the refractive index of the channel waveguide 110.

In various embodiments, the channel waveguide 110 may include a structure used to facilitate coupling into and out of the waveguide 110, for example, a grating coupler or a regular or inverse tapering region at an end region (e.g., a region near the end 108a and/or 108b), of the channel waveguide 110. For the regular tapering region, this may mean that a dimension (e.g., height and/or width) of the channel waveguide 110 may increase in a direction from the portion of the channel waveguide 110 towards (or to) the end region of the channel waveguide 110. For the inverse tapering region, this may mean that a dimension (e.g., height and/or width) of the channel waveguide 110 may decrease in a direction from the portion of the channel waveguide 110 towards (or to) the end region of the channel waveguide 110. In various embodiments, respective grating couplers or inverse tapering regions may be provided or formed at respective end regions of the channel waveguide 110.

In the context of various embodiments, the optical device 100a, 100b may further include a carrier 109, where the channel waveguide 110 may be formed or arranged on the carrier 109. The carrier 109 may include at least one of a dielectric substrate or a semiconductor substrate. In various embodiments, the carrier 109 may include a silicon-on-insulator (SOI) substrate or on a silicon substrate. This may mean that the optical device 100a, 100b may be formed on a silicon-on-insulator (SOI) platform or on a silicon substrate or platform. It should be appreciated that other substrates may also be used such as a silicon (Si) substrate, a silicon dioxide (SiOx) substrate, or an aluminum gallium arsenide (AlGaAs) substrate, among others. This may mean that other material platforms may also be used such as silicon nitride on silicon dioxide, or gallium arsenide on aluminum gallium arsenide, among others.

In the context of various embodiments, the channel waveguide 110 may have a height, H, in a range of between about 150 nm and about 2 μm, for example, between about 400 nm and about 1.5 μm, between about 200 nm and about 1 μm, or between about 600 nm and about 800 nm, e.g., about 200 nm, about 400 nm, about 600 nm or about 800 nm. It should be appreciated that the dimension of the height, H, of the channel waveguide 110 may be varied based on the waveguide design and/or platform. For example, the height of the channel waveguide may be dependent on the material that the grating is implanted as well as the width of the grating. As a non-limiting example, based on a silicon nitride core on a silicon substrate, or platform, the height, h, of the channel waveguide 110 may be about 800 nm.

In the context of various embodiments, the channel waveguide 110 may have a width, W, in a range of between about 500 nm and about 1.5 μm, for example, between about 500 nm and about 1 μm, between about 1 μm and about 1.5 μm, between about 1.5 μm and 2 μm, between about 1 μm and about 2 μm, between about 500 nm and about 2 μm, or between about 500 nm and about 1.5 μm, e.g., about 500 nm, about 1 μm, about 1.5 μm, or about 2 μm. For example, the width of the channel waveguide may be dependent on the material that the grating is implanted as well as the height of the grating. It should be appreciated that the dimension of the width, W, of the channel waveguide 110 may be varied based on the waveguide design and/or platform. As a non-limiting example, based on a silicon nitride core on a silicon substrate or platform, the width, W, of the channel waveguide 110 may be about 1.5 μm. Nevertheless, it should be appreciated that a width, W, of more than 1.5 μm may also be provided.

In the context of various embodiments, the portion of the channel waveguide 110 (where the plurality of optical elements 121a, 122a, 121b, 122b may be arranged) may have a length, L, of about 4 mm or more (e.g. ≥4 mm), for example, ≥5 mm, ≥6 mm, ≥7 mm, ≥8 mm or ≥10 mm. The length of the waveguide may depend on the length of the optical fiber of which the dispersion is to be compensated. For example, for compensation of a 5 km fiber, the length of the grating may be approximately 5 cm. For another example, to compensate for a 20 km fiber, 20 cm length of grating may be required.

Nevertheless, it should be appreciated that the plurality of optical elements 121a, 122a, 121b, 122b may be arranged along the entire length of the channel waveguide 110. In the context of various embodiments, the length, L, may also define the grating length.

In the context of various embodiments, the channel waveguide 110 may have a cross-sectional shape in the form of a square or a rectangle.

In the context of various embodiments, the channel waveguide 110 may be or may include at least one of a strip waveguide, a rib waveguide or a ridge waveguide.

In the context of various embodiments, the channel waveguide 110 may include at least one of a dielectric material or a semiconductor material. As a non-limiting example, the channel waveguide 110 may include silicon nitride (e.g. Si₃N₄). Accordingly, the optical device 100a, 100b of various embodiments may include a silicon nitride (e.g. Si₃N₄) channel waveguide. It should be appreciated that other materials may also be used for the channel waveguide 110, such as silicon (Si), silicon nitride (SiNx) or gallium arsenide (GaAs), among others. This may mean that the optical device 100a, 100b may have material platforms such as silicon on insulator (SOI), a silicon substrate or platform, silicon nitride on silicon dioxide, or gallium arsenide on aluminum gallium arsenide, among others.

FIG. 2 shows a block diagram of an optical system 200, according to various embodiments. The optical system 200 may include a tunable laser 201 (e.g. continuous wave laser operating at 1576.2 nm) configured to emit laser (e.g. light) in C-band and L-band. The optical system 200 may further include an optical transmitter (e.g. Mach Zehnder Optical Transmitter) cum pattern generator (e.g. Bit Error Rate Tester (BERT)) 202 coupled to the tunable laser 201 and configured to receive signals (e.g. optical signals) from the tunable laser 201. The optical transmitter cum pattern generator 202 may be configured to modulate the received signals using certain patterns generated by the patter generator. For example, NRZ and PAM4 data at 30 Gb/s and 60 Gb/s (30 Gbaud/s) respectively may be used in the optical system 200. The optical system 200 may include an optical fiber link 203 coupled to the optical transmitter cum pattern generator 202 and configured to receive the modulated signals from the optical transmitter cum pattern generator 202. The optical fiber link 203 may include a 2 km single mode fiber.

The optical system 200 may also include an erbium doped fiber amplifier (EDFA) and a bandpass filter (BPF) 204. The EDFA and BPF 204 may be coupled to output of the optical fiber 203 and configured to amplify the output and filer the amplified spontaneous emission noise outside of the signals. The optical system 200 may include an optical device 205 (e.g. the optical device 100a, 100b) configured to receive output from the EDFA and BPF 204 to compensate for the dispersion introduced during propagation in the optical fiber 203. The length of the waveguide (e.g. the plurality of optical elements) of the optical device 205 (e.g. the optical device 100a, 100b) may be configured according to a length of the optical fiber 203, for example, longer waveguide for longer optical fiber 203, so as to sufficiently compensate the dispersion. Accordingly, the optical device 205 (e.g. the optical device 100a, 100b) may be scalable to meet dispersion compensation requirements. The output from the EDFA and BPF 204 may be adjusted for transverse electric (TE) polarization before it is coupled into the optical device 205. The optical system 200 may include a photoreceiver 206 coupled to output of the optical device 205 and configured to convert optical signal to electrical signal. The optical system 200 may include a digital sampling oscilloscope 207 coupled to output of the photoreceiver 206 and configured to analyze the converted electrical signal for eye diagrams.

While FIG. 2 shows an example optical system 200 including the tunable laser 201, the optical transmitter cum pattern generator 202, the optical fiber 203, the EDFA and BPF 204, the optical device 205, the photoreceiver 206 and the digital sampling oscilloscope 207, in other embodiments any number of these components may be included in the optical system 200. In some embodiments, different and/or additional components may be included in the optical system 200.

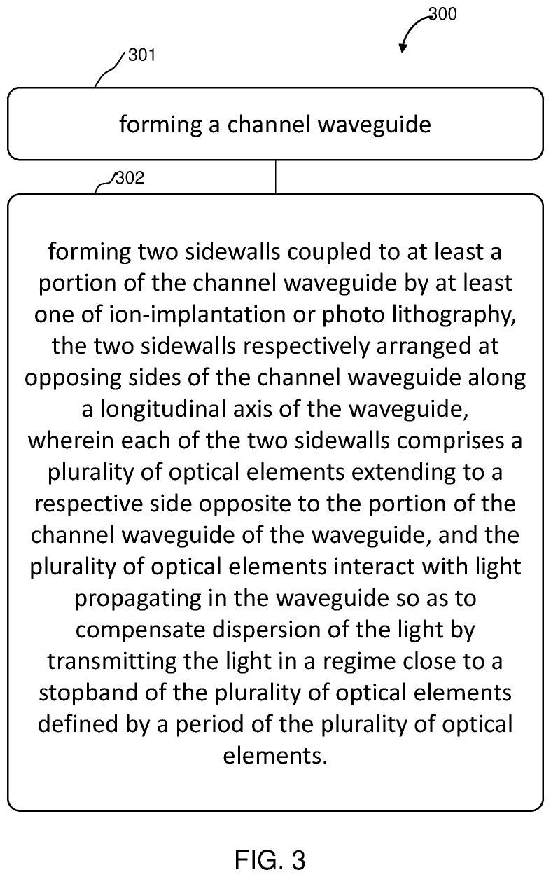

The fabrication for the optical device of various embodiments will now be described. FIG. 3 shows a flow chart 300 illustrating a method for forming an optical device (e.g. optical device 100a, 100b), according to various embodiments.

At 301, a channel waveguide is formed. The channel waveguide may be fabricated by chemical vapor deposition using plasma enhancement (Plasma enhanced chemical vapor deposition), or under low pressure (low pressure chemical vapor deposition). The channel waveguide may include an optical fiber attachment.

At 302, two sidewalls are formed integral to at least a portion of the channel waveguide by at least one of ion-implantation or photo lithography. The two sidewalls may be respectively arranged at opposing sides of the channel waveguide along a longitudinal axis of the waveguide. Each of the two sidewalls may include a plurality of optical elements extending to a respective side opposite to the portion of the channel waveguide of the waveguide. The plurality of optical elements may be configured to interact with light propagating in the waveguide so as to compensate dispersion of the light by transmitting the light in a regime close to a stopband of the plurality of optical elements defined by a period of the plurality of optical elements.

In various embodiments, the plurality of optical elements may have a sinusoidal profile. In other words, the channel waveguide may include sinusoidally modulated sidewalls. This may mean that the optical device of various embodiments may include a sinusoidally corrugated waveguide grating. It should be appreciated that other sidewall modulation types which provide an effective index modulation such as rectangular corrugations (e.g., rectangular profile), cladding modulation etc. may also be used. The sinusoidal sidewall configuration as show in FIG. 1A may be employed for its ease of fabrication with single-step lithography.

In various embodiments, the sidewalls may be apodized along the longitudinal axis of the waveguide by gradually increasing a modulated amplitude ΔW from zero at both ends to its maximum at the center of the sidewalls. In other words, the plurality of optical elements may be apodized in a manner that an amplitude ΔW is equal to zero at two ends of the sidewalls and gradually increases from the two ends to a center portion of the sidewalls. The amplitude at the center portion of the sidewalls may be about one tenth of a width of the channel waveguide. The apodization may help to eliminate or minimise group delay ripple as well as ripple within the passband. A maximum of ΔW at the center portion of the sidewalls may be 150 nm. In various embodiments, an upper cladding may be formed or arranged over the channel waveguide and the two sidewalls.

In various embodiments of forming the channel waveguide, at 301, a grating coupler or an inverse tapering region may be formed at an end region of the channel waveguide.

In various embodiments, the method may further include providing a carrier, wherein the channel waveguide may be formed on the carrier. The carrier may include at least one of a dielectric substrate or a semiconductor substrate. In various embodiments, the carrier may include a silicon-on-insulator (SOI) substrate, a silicon (Si) substrate, a silicon dioxide (SiOx) substrate, or an aluminum gallium arsenide (AlGaAs) substrate.

In the context of various embodiments, the channel waveguide may include at least one of a dielectric material or a semiconductor material. In various embodiments, the channel waveguide may include silicon (Si), silicon nitride (SiNx) or gallium arsenide (GaAs).

In the context of various embodiments, the channel waveguide 110 may have a height, H, in a range of between about 150 nm and about 2 μm, for example, between about 400 nm and about 1.5 μm, between about 200 nm and about 1 μm, or between about 600 nm and about 800 nm, e.g., about 200 nm, about 400 nm, about 600 nm or about 800 nm. It should be appreciated that the dimension of the height, H, of the channel waveguide 110 may be varied based on the waveguide design and/or platform. For example, the height of the channel waveguide may be dependent on the material that the grating is implanted as well as the width of the grating. As a non-limiting example, based on a silicon nitride core on a silicon substrate, or platform, the height, h, of the channel waveguide 110 may be about 800 nm.

In the context of various embodiments, the channel waveguide 110 may have a width, W, in a range of between about 500 nm and about 1.5 μm, for example, between about 500 nm and about 1 μm, between about 1 μm and about 1.5 μm, between about 1.5 μm and 2 μm, between about 1 μm and about 2 μm, between about 500 nm and about 2 μm, or between about 500 nm and about 1.5 μm, e.g., about 500 nm, about 1 μm, about 1.5 μm, or about 2 μm. For example, the width of the channel waveguide may be dependent on the material that the grating is implanted as well as the height of the grating. It should be appreciated that the dimension of the width, W, of the channel waveguide 110 may be varied based on the waveguide design and/or platform. As a non-limiting example, based on a silicon nitride core on a silicon substrate or platform, the width, W, of the channel waveguide 110 may be about 1.5 μm. Nevertheless, it should be appreciated that a width, W, of more than 1.5 μm may also be provided.

In the context of various embodiments, the portion of the channel waveguide 110 (where the plurality of optical elements 121a, 122a, 121b, 122b may be arranged) may have a length, L, of about 4 mm or more (e.g. ≥4 mm), for example, ≥5 mm, ≥6 mm, ≥7 mm, ≥8 mm or ≥10 mm. The length of the waveguide may depend on the length of the optical fiber of which the dispersion is to be compensated. For example, for compensation of a 5 km fiber, the length of the grating may be approximately 5 cm. For another example, for compensate for a 20 km fiber, 20 cm length of grating may be required.

In various embodiments, a depth (or modulation amplitude), ΔW, of the corrugations 104a may be in a range of between about 30 nm and about 500 nm, for example, between about 50 nm and about 400 nm, between about 100 nm and about 300 nm, or between about 120 nm and about 180 nm, e.g., about 100 nm, about 150 nm or about 180 nm. It should be appreciated that the dimension of the depth, ΔW, of the corrugations 104a may be varied based on the type of waveguide platform used. Further, the modulation amplitude, ΔW, of the sidewalls may be dependent on a width of the channel waveguide 110. For example, the modulation amplitude, ΔW, may be in a range of 30 nm to 500 nm for a width, W, of the channel waveguide of 1.5 μm. As a non-limiting example, based on a silicon nitride core on a silicon substrate or platform, the depth, ΔW, of the corrugations may be about 150 nm. The depth, ΔW, of the corrugations may change along the portion of the channel waveguide.

In the context of various embodiments, the channel waveguide 110 may have a cross-sectional shape in the form of a square or a rectangle.

In the context of various embodiments, the channel waveguide 110 may be or may include at least one of a strip waveguide, a rib waveguide or a ridge waveguide.

In the context of various embodiments, the channel waveguide 110 may include at least one of a dielectric material or a semiconductor material. As a non-limiting example, the channel waveguide 110 may include silicon nitride (e.g. Si₃N₄). Accordingly, the optical devices 100a, 100b of various embodiments may include a silicon nitride (e.g. Si₃N₄) channel waveguide. It should be appreciated that other materials may also be used for the channel waveguide 110, such as silicon (Si), silicon nitride (SiNx) or gallium arsenide (GaAs), among others. This may mean that the optical devices 100a, 100b may have material platforms such as silicon on SOI, a silicon substrate or platform, silicon nitride on silicon dioxide, or gallium arsenide on aluminum gallium arsenide, among others.

While the method described above is illustrated and described as a series of steps or events, it will be appreciated that any ordering of such steps or events are not to be interpreted in a limiting sense. For example, some steps may occur in different orders and/or concurrently with other steps or events apart from those illustrated and/or described herein. In addition, not all illustrated steps may be required to implement one or more aspects or embodiments described herein. Also, one or more of the steps depicted herein may be carried out in one or more separate acts and/or phases.

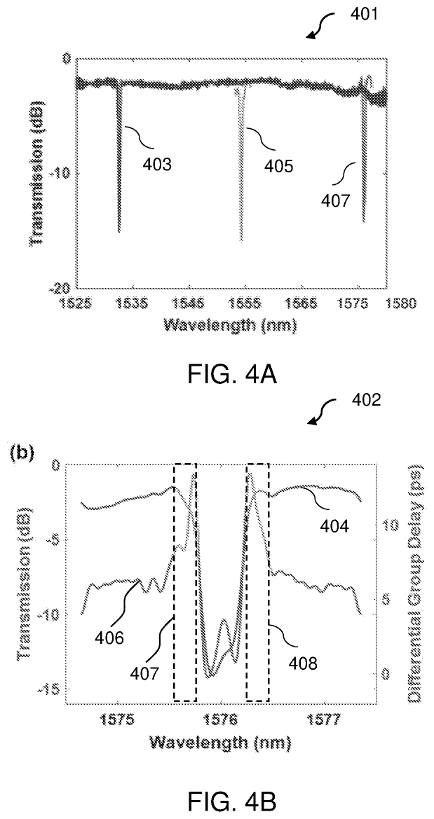

The measurement characterization for the optical device of various embodiments will now be described. FIG. 4A shows the transmission spectra 401 of optical devices having a coupled grating geometry (e.g., optical device 100a, 100b, FIGS. 1A and 1B). The transmission spectra of the optical devices are measured using a broadband, amplified spontaneous emission source and an optical spectrum analyzer. The optical devices are terminated with inverse tapers, and transverse electric light is coupled in using lensed fibers. Plot 403 shows the transmission (dB) for a grating having a period Λ=420 nm, plot 405 shows the transmission for Λ=427 nm, and plot 407 shows the transmission for Λ=434 nm, across wavelengths from 1525 nm to 1580 nm. The gratings with Λ=420 nm, 427 nm, 434 nm correspond to Bragg wavelengths of 1532 nm, 1554 nm and 1576 nm. This corresponds to an effective index of 1.82, close to the calculated value of 1.83. The insertion loss of the gratings is estimated to be 1±0.5 dB.

FIG. 4B shows the transmission spectrum and differential group delay characteristics 402 of an optical device having a coupled grating geometry (e.g., optical device 100a, 100b, FIGS. 1A and 1B). The group delay of an optical element may be essentially the time delay experienced by a light pulse for propagation through that element. That time delay may generally depends on the optical wavelength. The group delay may have the units of a time (e.g. picoseconds) and generally (in dispersive media) depend on the optical frequency and possibly on the polarization state and the optical mode in case of a waveguide. The group delay dispersion (also sometimes called second-order dispersion) of an optical element is a quantitative measure for chromatic dispersion. It is defined as the derivative of the group delay. In some situations, a quantity of primary interest is a differential group delay, i.e., a difference of two different group delays (e.g. between two polarization directions). The differential group delay shown in FIG. 4B is a measure of forward and backward propagating optical fields in the optical device.

The group delay profile measured uses the dispersion analyzer. Plot 404 shows the transmission spectrum (dB) and plot 406 shows the differential group delay characteristics (ps) for Λ=434 nm (a center wavelength of 1576 nm), across wavelengths from 1574.5 nm to 1577.5 nm. It is observed that on the blue-side (i.e. shorter wavelength) of the grating stopband, the differential group delay increases rapidly as the wavelength increases, whereas on the red-side (i.e. longer wavelength) of the grating stopband, the differential group delay decreases rapidly as the wavelength increases. In other words, the differential group delay increases rapidly towards the stopband of the grating as denoted in boxes 407, 408, resulting a high dispersion.

Consequently, the red-side of the stopband is the region in which dispersion is characterized to be normal, providing a delay to shorter wavelengths relative to the longer wavelengths. It is this region of the grating which should be used for the compensation of single mode fiber dispersion at the C- and L-bands. In standard single mode optical fiber operating at the 1550 nm, the dispersion may be anomalous with a value of 16 ps/nm/km. Consequently, over a 2 km fiber length, normal dispersion with a magnitude of −32 ps/nm may be needed for compensation, The dispersion that is extracted from the group delay vs. wavelength profile as shown in FIG. 4B is −31 ps/nm, which is close to the magnitude of dispersion required to completely compensate for 2 km of SMF dispersion (32 ps/nm). Analogously, the blue-side of the stopband is the region in which dispersion is characterized to be anomalous, providing a delay to longer wavelengths relative to the shorter wavelengths. This region of the grating may be used for the compensation of negative dispersion.

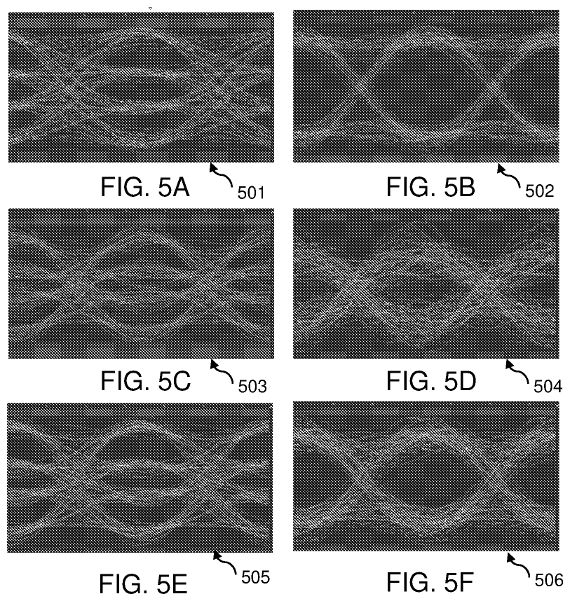

FIGS. 5A, 5C and 5E show eye diagrams 501, 503, 505 using a digital sampling oscilloscope (e.g. digital sample oscilloscope 207) for 30 Gbaud/s PAM4 data; FIGS. 5B, 5D and 5F show eye diagrams 502, 504, 506 using a digital sampling oscilloscope (e.g. digital sample oscilloscope 207) for 30 Gb/s NRZ data. FIGS. 5A and 5B show eye diagrams measured from output of the transmitters (e.g. optical transmitter 202); FIGS. 5C and 5D show eye diagrams measured from output of the 2 km single mode fibre (e.g. optical fiber 203); FIGS. 5E and 5F show eye diagrams measured from output of optical devices (e.g. optical devices 100a, 100b, 205).

After propagation in 2 km of optical fiber, eye closure in eye diagram 504 is observed to be quite significant for the 30 Gb/s NRZ data as shown in FIG. 5D, and eye closure in eye diagram 503 is observed to occur to some extent for 30 Gbaud/s PAM4 data as shown in FIG. 5C. Upon undergoing dispersion compensation using the grating, the eye diagram 505 as shown in FIG. 5E for 30 Gbaud/s PAM4 data and the eye diagram 506 as shown in FIG. 5F for the 30 Gb/s NRZ data are restored close to the respective original state (501, 502) prior to propagation in the single mode fiber. The results show that transmission through the grating devices on the red side of the grating stopband where the measured dispersion is-31 ps/nm, can be used effectively for the compensation of the anomalous dispersion experienced in the 2 km fiber.

While the disclosure has been particularly shown and described with reference to specific embodiments, it should be understood by those skilled in the art that various changes in form and detail may be made therein without departing from the spirit and scope of the disclosure as defined by the appended claims. The scope of the disclosure is thus indicated by the appended claims and all changes which come within the meaning and range of equivalency of the claims are therefore intended to be embraced.

1. An optical device for dispersion compensation comprising:
a channel waveguide and two sidewalls coupled to at least a portion of the channel waveguide, the two sidewalls respectively arranged at opposing sides of the channel waveguide along a longitudinal axis of the channel waveguide,
wherein each of the two sidewalls comprises a plurality of optical elements arranged along the channel waveguide of the waveguide, and the plurality of optical elements are configured to interact with light propagating in the waveguide so as to compensate dispersion of the light by transmitting the light in a regime close to a stopband of the plurality of optical elements defined by a period of the plurality of optical elements.

2. The optical device of claim 1, wherein the plurality of optical elements are configured to interact with the light propagating in the channel waveguide so as to compensate positive dispersion of the light by transmitting the light in a regime close to a red-side of the stopband of the plurality of optical elements where the transmission causes negative dispersion.

3. The optical device of claim 1, wherein the plurality of optical elements have a sinusoidal profile.

4. The optical device of claim 3, wherein the sidewalls are apodized in a manner that an amplitude is equal to zero at two ends of the sidewalls and gradually increases from the two ends to a center portion of the sidewalls.

5. The optical device of claim 4, wherein the amplitude at the center portion of the sidewalls is about one tenth of a width of the channel waveguide of the waveguide.

6. (canceled)

7. (canceled)

8. (canceled)

9. The optical device of claim 1, further comprising a cladding arranged over the channel waveguide and the plurality of optical elements.

10. (canceled)

11. The optical device of claim 1, further comprising:
a grating coupler or an inverse tapering region at an end region of the channel waveguide.

12. (canceled)

13. The optical device of claim 1, wherein the plurality of optical elements form a Bragg grating.

14. The optical device of claim 13, wherein the stopband of the plurality of optical elements is configured to be longer than a wavelength of the light having the dispersion by a range of 0.1 nm to 1 nm.

15. An optical system comprising:
an optical transmitter for providing at least one optical signal;
an optical fiber coupled to the optical transmitter for receiving and transmitting the at least one optical signal;
an optical device for compensating dispersion of the at least one optical signal induced by the transmission in the optical fiber; and
an optical receiver,
wherein the optical device comprises:
a channel waveguide and two sidewalls coupled to at least a portion of the channel waveguide, the two sidewalls respectively arranged at opposing sides of the channel waveguide along a longitudinal axis of the channel waveguide,
wherein each of the two sidewalls comprises a plurality of optical elements arranged along the channel waveguide of the waveguide, and the plurality of optical elements are configured to interact with light propagating in the waveguide so as to compensate dispersion of the light by transmitting the light in a regime close to a stopband of the plurality of optical elements defined by a period of the plurality of optical elements.

16. The optical system of claim 15, wherein the optical device is integrated with the optical transmitter or the optical receiver in a manner that the optical transmitter or the optical receiver is a system-on-a-chip.

17. The optical system of claim 15, wherein the optical transmitter comprises a multiwavelength optical transmitter for providing a plurality of wavelength-distinct optical signal and the optical receiver comprises a multiwavelength optical receiver.

18. The optical system of claim 15, wherein the multiwavelength optical transmitter is configured to provide C-band and L-band wavelength optical signals.

19. The optical system of claim 15, wherein the optical transmitter is configured to provide modulated signals including Pulse Amplitude Modulation (PAM) and non-return-to-zero (NRZ) modulated signals.

20. The optical system of claim 15, wherein the optical fiber is a single mode fiber.

21. The optical system of claim 20, wherein a length of the optical fiber is at least 2 km.

22. The optical system of claim 15, further comprising:
an erbium doped fiber amplifier and a bandpass filter coupled between the optical fiber and the optical device,
wherein the optical device is configured to receive an output from the bandpass fiber and to compensate dispersion of the output.

23. The optical system of claim 15, wherein the optical receiver is configured to convert optical signals to electrical signals.

24. The optical system of claim 23 further comprising:
a digital sampling oscilloscope for analyzing the converted electrical signals.

25. A method for forming an optical device, the method comprising:
forming a channel waveguide; and
forming two sidewalls coupled to at least a portion of the channel waveguide by at least one of ion-implantation or photo lithography, the two sidewalls respectively arranged at opposing sides of the channel waveguide along a longitudinal axis of the waveguide,
wherein each of the two sidewalls comprises a plurality of optical elements extending to a respective side opposite to the portion of the channel waveguide of the waveguide, and the plurality of optical elements interact with light propagating in the waveguide so as to compensate dispersion of the light by transmitting the light in a regime close to a stopband of the plurality of optical elements defined by a period of the plurality of optical elements.

26. An optical device comprising:
a waveguide; and
a Bragg grating defined in at least a portion of the waveguide,
wherein the Bragg grating is configured to interact with light propagating in the waveguide so as to compensate dispersion of the light by transmitting the light in a regime close to a stopband of the Bragg grating.

27. A method in dispersion compensation of light using an optical device, the method comprising:
transmitting the light in a regime close to a stopband of a plurality of optical elements defined by the period of the plurality of optical elements,
wherein the light has a positive dispersion and the light has a wavelength longer than the stopband of the plurality of optical elements by a range of 0.1 nm to 1 nm, or
wherein the light has a negative dispersion and the light has a wavelength shorter than the stopband of the plurality of optical elements by a range of 0.1 nm to 1 nm, and
wherein the optical device comprises:
a channel waveguide and two sidewalls coupled to at least a portion of the channel waveguide, the two sidewalls respectively arranged at opposing sides of the channel waveguide along a longitudinal axis of the channel waveguide,
wherein each of the two sidewalls comprises the plurality of optical elements arranged along the channel waveguide of the waveguide, and the plurality of optical elements are configured to interact with light propagating in the waveguide so as to compensate dispersion of the light by transmitting the light in the regime close to the stopband of the plurality of optical elements defined by a period of the plurality of optical elements.
